(19) United States
(12) Patent Application Publication
(10) Pub. No.: US 2014/0087048 A1
(43) Pub. Date: Mar. 27, 2014

(54) PIZZA PIE PREPARATION DEVICE AND RELATED METHODS

(71) Applicant: EZ TOPPING SYSTEMS, LLC, Cincinnati, OH (US)

(72) Inventors: Ross Webster, Cincinnati, OH (US); Gary Kestin, Mason, OH (US)

(73) Assignee: EZ TOPPING SYSTEMS, LLC, Cincinnati, OH (US)

(21) Appl. No.: 13/627,525

(22) Filed: Sep. 26, 2012

(51) Int. Cl. A23P 1/08; B26D 7/06; B26D 3/00; B26D 7/32

(52) U.S. Cl. 426/518; 83/78; 83/165; 83/76.1; 83/663

(57) ABSTRACT

A pizza pie preparation device for placing sliced toppings from a topping stick onto a pizza pie in a predetermined pattern includes a storage unit for storing topping sticks, a cutting tool adjacent to the storage unit for slicing at least one topping stick, and a carrier positioned below the cutting tool for translating and rotating the pizza pie so the sliced toppings are placed onto the pizza pie in the predetermined pattern.

### TECHNICAL FIELD

This invention is generally related to devices and methods for placing a sliced topping onto a pizza pie. More particularly, the invention relates to a pizza pie preparation device for storing topping sticks, for cutting the topping sticks into sliced toppings, and for positioning the sliced toppings onto a pizza pie.

### BACKGROUND

The preparation of a pizza pie generally includes first kneading and tossing dough to the preferred size and thickness. Once the dough has been properly prepared, sauces or cheeses may be added to the tossed dough. Finally, various toppings are added to the pizza pie at the request of the customer or direction of the chef prior to being thoroughly cooked and served to the customer. Delivering a superior pizza pie to the customer often requires a wide variety of available toppings that are fresh, sliced, properly positioned, and quickly prepared in a safe and cost-effective manner.

Traditionally, the preparation of toppings for a pizza pie is completed by hand. While this may be performed with only the necessary ingredients and a sharp kitchen knife, the operation itself is cost and labor intensive. Furthermore, toppings may be cut immediately prior to the preparation of the pizza pie to maintain optimum freshness. However, such preparation is time consuming and may be difficult to manage in a bustling restaurant kitchen. In response, ingredients may be prepared in advance to decrease preparation time, but at the cost of freshness. Also, toppings, such as pepperoni, may be difficult to quickly position slice-by-slice in a predetermined, even pattern. This additional time further strains an already bustling kitchen environment and decreases efficiency still further.

Even with proper management of a complex kitchen environment, the rush to replenish topping supplies can result in inconsistently prepared toppings, wasted product, and decreased attention to safety. Moreover, the skill set required to simultaneously organize customer orders, prepare dough, slice toppings, position toppings, and bake the pizza pie requires either highly skilled workers or multiple workers, both of which present high costs to the restaurateur.

In response to such problems, pizza pies may also be produced in a larger, more efficient, industrial setting. For example, such industrial preparation has spawned a frozen pizza industry, which seeks to quickly deliver high volumes of pizza pies at a low cost. To achieve these goals, large manufacturing machines have been designed to make an entire set of toppings for addition to the pizza pie in a single cut. However, the very nature of industrial production of pizza pies requires freezing, transportation, and later cooking, which fails to duplicate the desirable freshness and taste of individually prepared pizza pies. In addition, such large equipment is inapplicable to the restaurant environment given its size, large production volumes, and technical maintenance.

Therefore, there is a need for devices and methods for use in individual pizza pie preparation that address the challenges discussed above.

### SUMMARY

The present invention provides a pizza pie preparation device for storing topping sticks, for cutting the topping sticks into sliced toppings, and for positioning the sliced toppings onto an individual pizza pie.

According to an embodiment of the invention, the pizza pie preparation device generally comprises a storage unit for storing the plurality of topping sticks, a cutting tool positioned adjacent the storage unit and configured to slice at least one of the topping sticks, and a pizza pie carrier positioned below the cutting tool and configured to translate and rotate a pizza pie. Moreover, the cutting tool and carrier are operatively driven to sequentially position the sliced topping from at least one of the topping sticks and onto the pizza pie in a predetermined pattern. The cutting tool, which according to one embodiment of the invention slices from one topping stick at a given instance, is also independently driven from the carrier.

Positioned between the carrier and the cutting tool is a chute configured to guide sliced topping falling under the influence of gravity toward the pizza pie. According to one embodiment of the invention, the chute is a funnel. In addition, the embodiment further includes a CPU and a carrier drive unit operatively connected to both the carrier and CPU. The CPU and carrier drive unit are each in communication to direct the carrier drive unit to position the pizza pie via the carrier relative to the sliced topping falling through the chute.

According to one embodiment, the pizza pie preparation device includes a frame and a protective housing surrounding at least a portion of the frame which defines a chamber. In addition, a plurality of topping chambers is rotatably mounted to the frame about a first axis of rotation. The plurality of topping chambers is thereby mounted to extend into the chamber. Below the plurality of topping chambers is a storage bottom which includes an aperture. Each of the plurality of topping chambers is sequentially alignable with the aperture such that a selected one of the plurality of topping chambers is aligned with the aperture. In addition, a disk with a blade affixed thereto is rotatably mounted below the storage bottom to the frame and includes a second axis of rotation. The carrier may further be defined as being on a guide rail, and having a base and a turntable. The guide rail is also connected to the frame within the chamber and below the disk. While the base is translatably mounted to the guide rail, the turntable is rotatably mounted to the base so as to properly position the pizza pie placed onto the turntable relative to the sliced topping falling through the chute. Thereby, the base and turntable are operatively driven to translate and rotate the pizza pie to a series of predetermined positions so that sliced toppings are sequentially deposited on the pizza pie in a predetermined pattern.

According to another embodiment, a cutting tool for use with the pizza pie preparation device includes a disk having an axis of rotation, a blade, and an elongated opening projecting through the disk and extending about the axis of rotation. The disk includes upper and lower surfaces, and the elongated opening projects between the upper and lower surfaces. The blade includes a first blade end, a second blade end, and a varying cutting radius from the axis of rotation that varies from the first blade end to the second blade end. Particularly, the cutting radius either increases or decreases from the first blade end to the second blade end. The blade, which is connected to the disk, also overhangs at least a portion of the elongated opening, which is curved.

A method is also provided for placing sliced toppings onto a pizza pie in a predetermined pattern by positioning the pizza pie in a series of predetermined positions so the toppings are placed on the pizza pie in a predetermined pattern. Such positioning includes both translating the pizza pie along a first axis and rotating the pizza pie about a second axis. In addition, topping sticks are sliced with a cutting tool and dropped onto the pizza pie. The steps of positioning, slicing, and dropping are sequentially repeated until the predetermined pattern is complete.

By virtue of the foregoing, there is thus provided a pizza pie preparation device for storing topping sticks, for cutting the topping sticks into sliced toppings, and for positioning the sliced toppings onto a pizza pie. These and other advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and together with the general description of the invention given above and the detailed description of the embodiments given below, serve to explain the principles of the present invention.

FIG. 1 is a perspective view of a pizza pie preparation device constructed according to the concepts of the invention.

FIG. 2 is a further perspective view of the pizza pie preparation device of FIG. 1.

FIG. 3 is a cross section view taken generally along line 3-3 of FIG. 2 and showing features of a topping storage unit, a cutting tool, a pizza pie carrier, and a pizza pie preparation chamber.

FIG. 4 is a top plan view of the cutting tool used in the pizza pie preparation device of FIGS. 1-3.

FIG. 5A is a cross section view of the cutting tool of FIG. 4 taken along line 5A-5A and showing a blade beginning a cut in a topping stick.

FIG. 5B is a view like FIG. 5A, taken along line 5B-5B of FIG. 4, and showing the blade at an intermediate position through the topping stick.

FIG. 5C is a view like FIGS. 5A and 5B, taken along line 5C-5C of FIG. 4, and showing a sliced topping cut from the topping stick by the blade.

FIG. 6 is a partial disassembled view of the pizza pie preparation device of FIGS. 1-3 and showing internal features thereof.

FIG. 7 is a further partial disassembled view like FIG. 6, but showing additional internal features of the pizza pie preparation device.

### DETAILED DESCRIPTION

Referring now to the figures, a pizza pie preparation device is shown and is generally indicated by the numeral 10. Pizza pie preparation device 10 is configured to store topping sticks, to cut the topping sticks to create sliced toppings, and to position the sliced toppings onto an individual pizza pie in a desired pattern. Pizza pie preparation device 10 is sized and configured to be used in a restaurant or pizza parlor setting, and advantageously can be situated on a kitchen countertop. Additionally, the device 10 discussed herein may also be incorporated into other features of the kitchen environment such as a built-in refrigerator, cabinet, countertop, and the like.

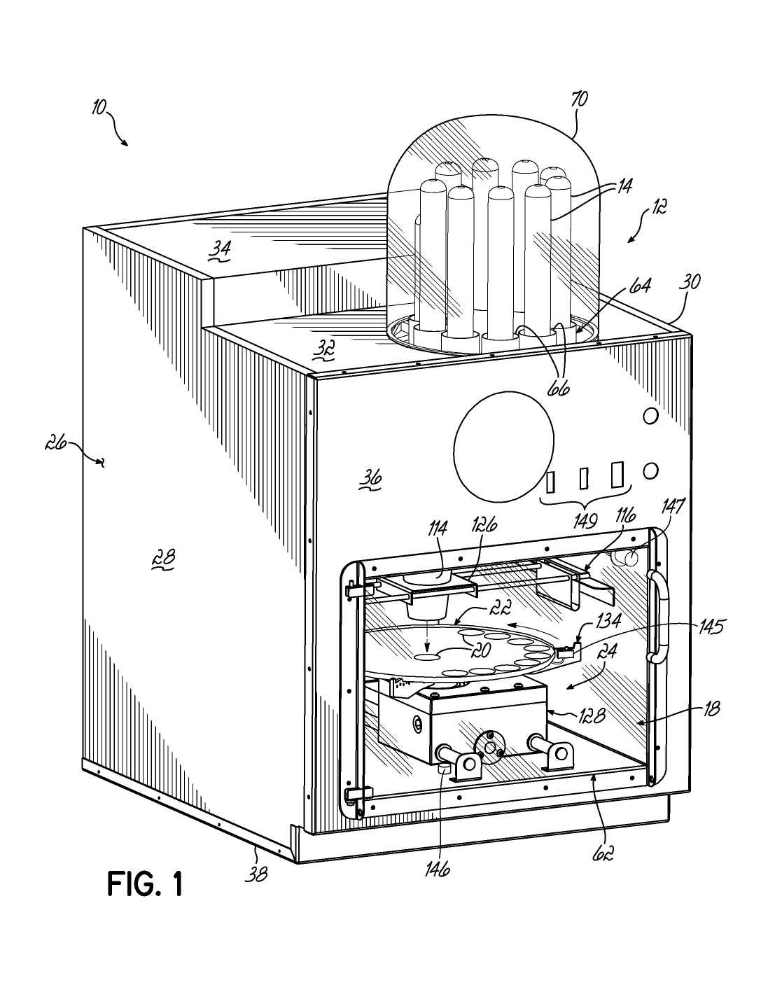

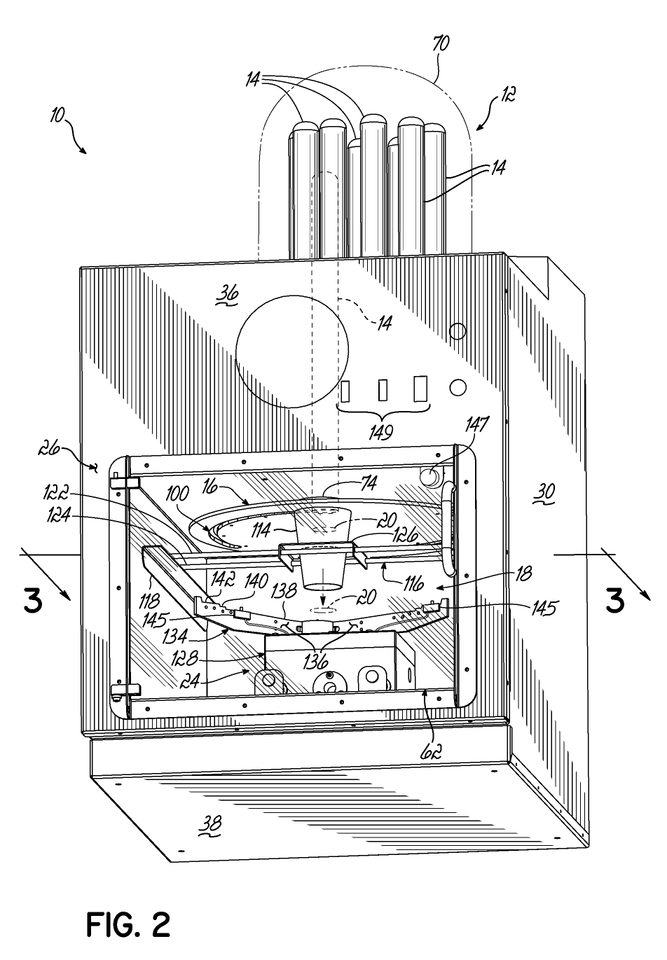

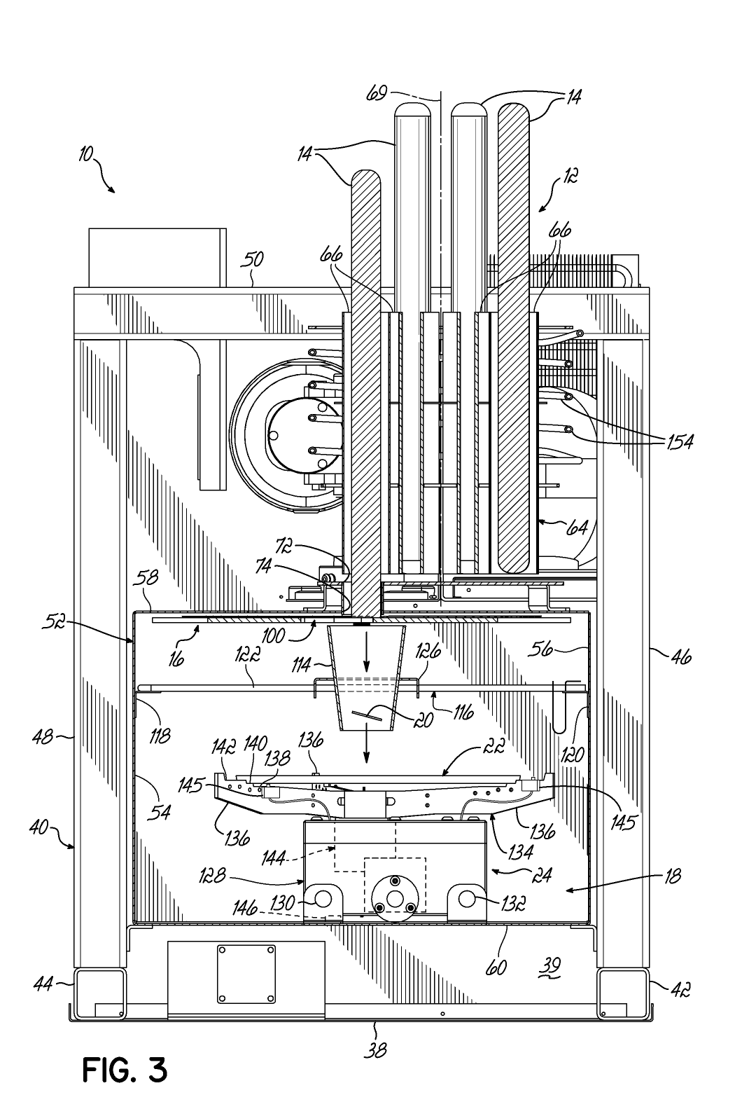

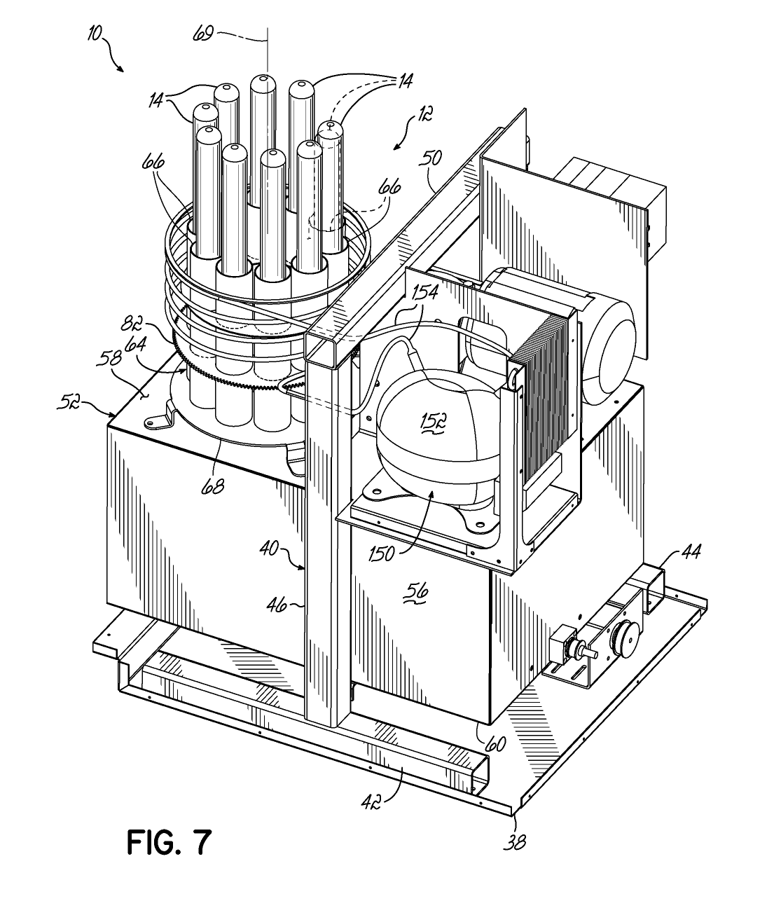

With reference to FIGS. 1 and 2, the pizza pie preparation device 10 includes a topping storage unit 12 for storing a plurality of topping sticks 14, a cutting tool 16 for cutting the topping sticks 14, and a pizza pie preparation chamber 18 in which sliced toppings 20 are positioned onto a pizza pie 22. Particularly, it is contemplated that the topping sticks 14 could be pepperoni, which is a traditional and popular topping. However, other topping sticks 14 that are appropriately sized and compatible with the device 10 could also be used as the topping stick 14. Pizza pie 22 is supported on a pizza pie carrier 24 in the preparation chamber 18. Pizza pie preparation device 10 includes an outer protective housing 26, which includes side panels 28, 30, upper panels 32, 34, a front panel 36, a bottom panel 38, and a rear panel 39 (shown in FIG. 3). Inside the protective housing 26 is a frame 40 (FIGS. 3, 6, and 7) that supports components of the pizza pie preparation device 10. The frame 40 includes base members 42, 44, upwardly extending members 46, 48, and a cross member 50 that extends between and connects the upwardly extending members 46, 48. Preparation chamber 18 is defined by a box-like structure 52 inside the housing 26 that includes side walls 54, 56, an upper wall 58, and a lower wall 60. As best seen in FIGS. 1 and 2, an access door 62 is provided in the front panel 36 of the protective housing 26 in order to provide a user access into the preparation chamber 18 (such as to place a pizza pie 22 therein, or to remove a pizza pie 22 therefrom). While the exemplary embodiment of the frame 40 includes the base members 42, 44, upwardly extending members 46, 48, a cross member 50, and upwardly extending members 46, 48, it will be appreciated that any frame 40 adapted to support the components of the pizza pie preparation device 10 may be used. Accordingly, the device 10 is not intended to be limited to exemplary embodiment of the frame 40.

The topping storage unit 12 is positioned generally above the preparation chamber 18 and is configured to store a plurality of topping sticks 14. To that end, a topping bin 64 is provided in the topping storage unit 12 that includes a plurality of generally cylindrical topping chambers 66, which are open at each end. The topping bin 64 is positioned above a storage bottom 68, which is supported above the upper wall 58 of the box-like structure 52 that defines the preparation chamber 18. The topping bin 64 is rotatable about a central rotation axis 69 generally parallel with the major axes of the topping chambers 66 and the topping sticks 14.

A topping cover 70 extends above the topping bin 64 and the topping sticks 14, and, as shown in FIG. 1, extends through and above the upper panel 32 of the protective housing 26. Advantageously, the topping cover 70 is made of a clear material so that a user can observe the topping sticks 14 in the pizza pie preparation device 10.

As shown in FIG. 3, the storage bottom 68 includes an aperture 72 sized to allow an individual topping stick 14 to fit therethrough. The aperture 72 is positioned directly above another aperture 74 in the upper wall 58 of the box-like structure 52, with the aperture 74 also sized to allow an individual topping stick 14 to fit therethrough. Thus, when a topping stick 14 is positioned above the apertures 72, 74, it is free to fall downwardly in its topping chamber 66 through the apertures 72, 74 to the cutting tool 16 in the preparation chamber 18 (the cutting tool 16 and its operation will be explained below).

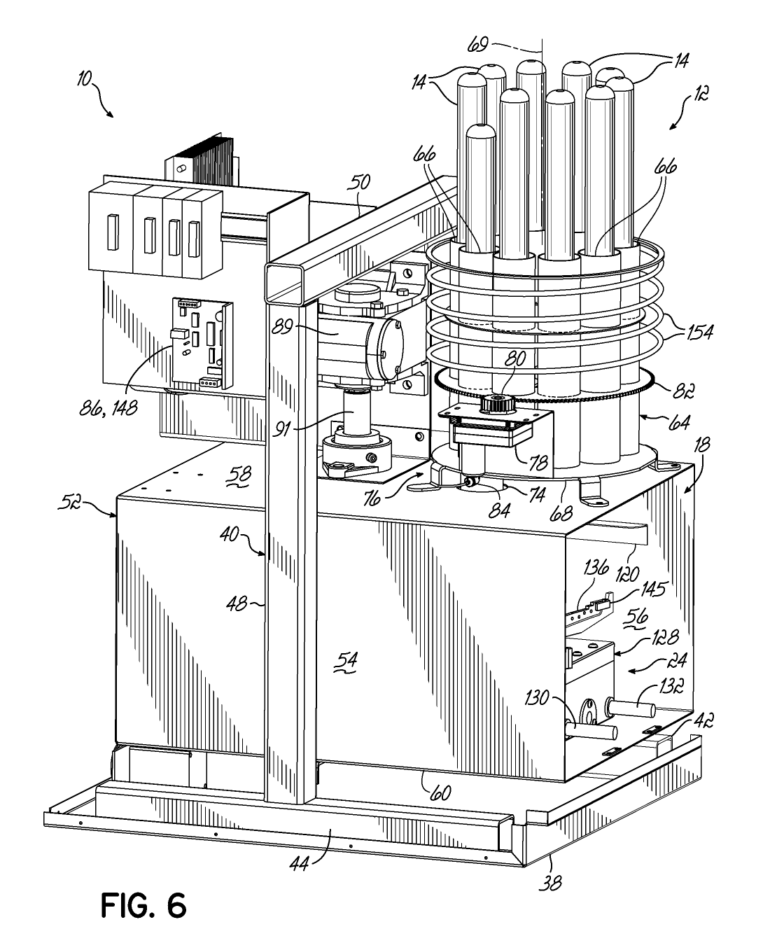

FIG. 6 shows a topping bin drive unit 76 is provided to rotate the topping bin 64 so as to maintain a supply of topping sticks 14 to the cutting tool 16. The topping bin drive unit 76 includes a motor 78 that drives a gear 80 that engages a toothed surface 82 about the periphery of the topping bin 64. Activation of the motor 78 and rotation of the gear 80 causes rotation of the topping bin 64 about its rotation axis 69. A topping stick sensor 84 is provided for sensing when a topping stick 14 is extending through the apertures 72, 74 and is being provided to the cutting tool 16. Advantageously, the topping stick sensor 84 can also detect when an individual topping chamber 66 is aligned with the apertures 72, 74. Both the topping bin drive unit 76 and the topping stick sensor 84 are connected with a CPU 86 that controls the drive unit 76. In particular, the CPU 86 directs the drive unit 76 to rotate the topping bin 64 in response to the topping stick sensor 84 so as to maintain a topping stick 14 in a topping chamber 66 aligned with the apertures 72, 74. For example, if one of the topping sticks 14 is depleted, this is sensed by the topping stick sensor 84 and the CPU 86 directs the drive unit 76 to rotate the topping bin 64 until another topping chamber 66 having another topping stick 14 is aligned with the apertures 72, 74. In the embodiment shown, the exemplary topping stick sensor 84 is a light sensor. As one of the topping sticks 14 is positioned to extend through the apertures 72, 74, one of the topping sticks 14 blocks a light beam emanating from the topping stick sensor 84. In the event that one of the topping sticks 14 extending through the apertures 72, 74 is depleted, the light beam is no longer broken, which is communicated to the CPU 86. Thus, another topping stick 14 can be provided to the cutting tool 16 at the direction of the CPU 86. Also, the topping chambers 66 may be indexed, such as with an encoder, and in communication with the CPU 86 such that the CPU 86 can track the position of topping chambers 16 in order to provide more efficient placement of the topping sticks 14 relative to the pizza pie 22.

The cutting tool 16 is configured to cut the topping sticks 14 and create sliced toppings 20 for the pizza pie 22. In particular, the cutting tool 16 is a rotating device driven by cutting motor 89 and that cuts a topping stick 14 with a blade 90. Extending from the cutting motor 89 and coupled thereto is a driveshaft 91 also connected to the cutting tool 16. According to the present embodiment, the cutting motor 89 is advantageously mounted at a fixed position via a motor mount to the frame 40. Also, the cutting tool 16 may be indexed, such as with an encoder, and in communication with the cutting motor 89 via the CPU 86 in order to provide more efficient and accurate placement of the topping slices 20.

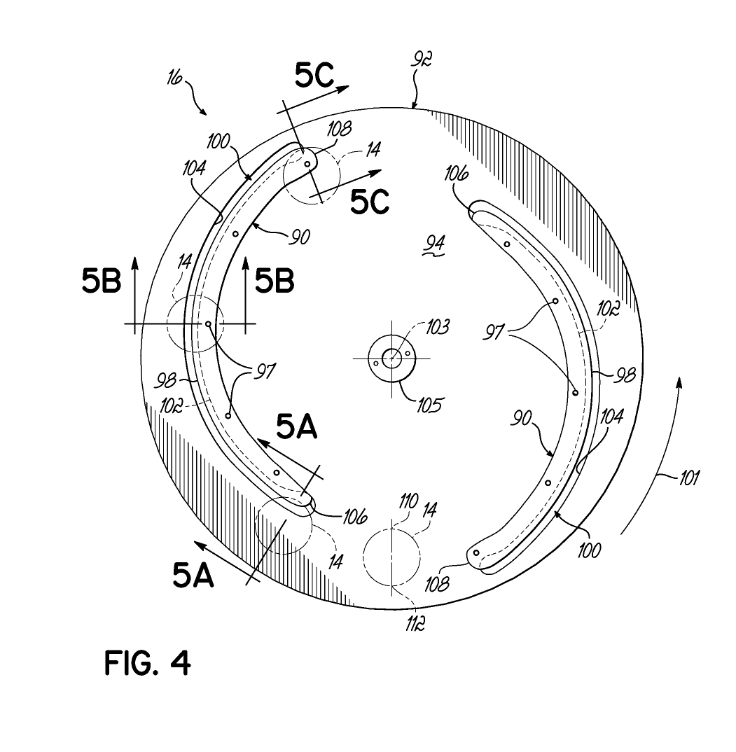

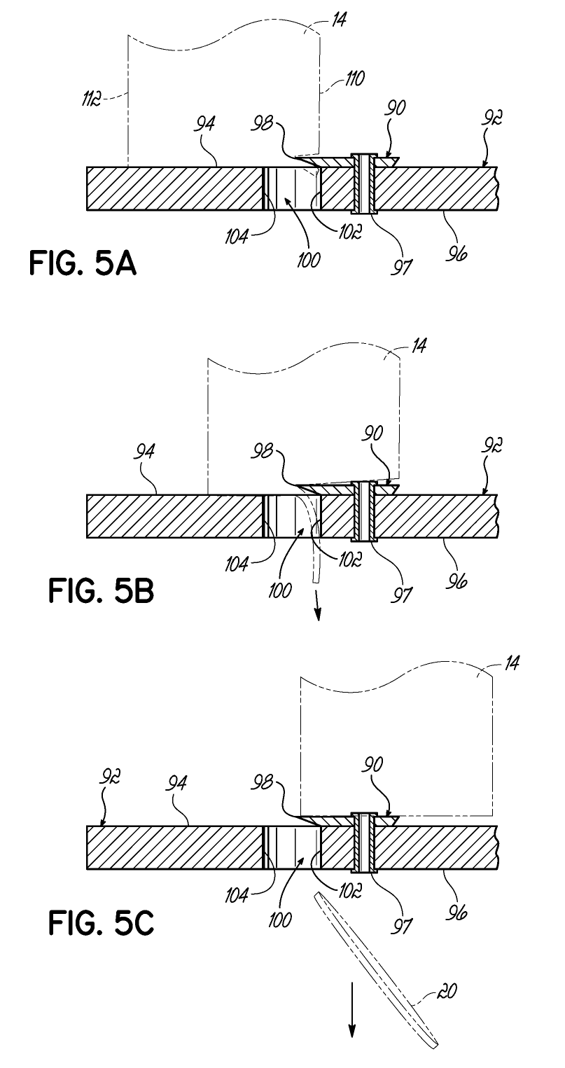

Referring to FIGS. 4 and 5A-5C, the cutting tool 16 includes a disk 92 having an upper surface 94 and a lower surface 96. The blade 90 is attached to the upper surface 94 by rivets 97 and includes a beveled leading edge 98 for attacking a topping stick 14. An elongated opening 100 projects through the disk 92 from the upper surface 94 to the lower surface 96, and generally includes an inside surface 102 (shown mostly in dashed lines in FIG. 4) opposite an outside surface 104. A portion of the blade 90 including the leading edge 98 overhangs a portion of the elongated opening 100. Particularly, the blade 90 extends from a portion of the upper surface 94 and over a region of the elongated opening 100 near the inside surface 102. Advantageously, the blade 90 does not extend the entire distance across the elongated opening 100 to the outside surface 104. As shown, the cutting tool 16 includes two identical blades 90 and two identical elongated openings 100, so a description of one of blades 90 and elongated openings 100 also describes the other. It will be appreciated that by including two blades 90, each complete rotation of the disk 92 will cut a topping stick 14 twice and produce two sliced toppings 20.

As the blade 90 cuts a topping stick 14 to create a sliced topping 20, the portion of the topping stick 14 cut by the blade 90 enters, and ultimately falls through the elongated opening 100. With reference to FIG. 4, the disk 92 has an axis of rotation 103 concentric with a central opening 105, and both the blade 90 and the elongated opening 100 have arcuate shapes that are generally disposed around that axis of rotation 103 (note direction of rotation 101). Note that the cutting tool 16 and driveshaft 91 are coaxial and connected at the central opening 105. Moreover, the blade 90 extends between a first end 106 and a second end 108. The leading edge 98 of the blade 90 follows a path of varying radius from the central opening 105 between the first end 106 and the second end 108. Particularly, the leading edge 98 follows a path of increasing radius between the first end 106 and the second end 108; however, it will be appreciated that varying radius may also be a decreasing radius. According to the exemplary embodiment, the first end 106 is a shorter radial distance from the central opening 105 than the second end 108. Thus, and with reference to a viewer's perspective observing the upper surface 94 of the disk 92, when the disk 92 rotates in the direction of rotation 10, the first end 106 leading the second end 108, the position of the leading edge 98 advances radially outward from a closer position at the first end 106 to a more distant position at the second end 108. The leading edge 98 may advance radially inward in the case of the decreasing radius. In either case, when the blade 90 encounters the topping stick 14 through its rotation, the blade 90 cuts deeper into the topping stick 14, eventually cutting through the entirety of the topping stick 14 to create the topping slice 20.

As shown in the present embodiment, it will be appreciated that the position of the topping stick 14 being cut by the cutting tool 16 does not change during the cutting. Rather, the cutting tool 16 rotates so that the blade 90 is brought into cutting contact with the topping stick 14. Referring to FIGS. 4 and 5A-5C, the relative position of the topping stick 14 (shown in dashed lines in FIG. 4), the blade 90, and the elongated opening 100 during cutting is shown. Before coming into cutting contact with the blade 90, the topping stick 14 rides on the upper surface 94 of the disk 92. An inner portion 110 of the topping stick 14 is radially nearer the central opening 105 than an outer portion 112.

As the disk 92 rotates, the blade 90 advances toward the topping stick 14 with the first end 106 leading to contact the topping stick 14 in advance of the second end 108. The beveled leading edge 98 of the blade 90 engages the topping stick 14, generally in the region of the inner portion 110 and begins to cut the topping stick 14. This is shown in FIG. 4 with reference to line 5A-5A and in FIG. 5A. As the topping stick 14 is cut, the beveled leading edge 98 of the blade 90 urges a portion of the topping stick 14 downwardly and into the elongated opening 100 (FIG. 5A).

As the disk 92 continues to rotate, and as the beveled leading edge 98 follows a path of increasing radius, the blade 90 cuts further into the topping stick 14. This is shown in FIG. 4 with reference to line 5B-5B and in FIG. 5B, with the blade 90 at an intermediate portion of the topping stick 14 between the inner portion 110 and the outer portion 112. As the topping stick 14 is further cut, the beveled leading edge 98 continues to urge a portion of the topping stick 14 downwardly under the influence of gravity into the elongated opening 100, and a portion thereof can engage the inside surface 102 of the elongated opening 100 (FIG. 5B).

As the disk 92 continues to rotate, the beveled leading edge 98 continues to follow the path of increasing radius and the blade 90 cuts further into the topping stick 14 until it is cut completely through (generally in the region of the outer portion 112). This is shown in FIG. 4 with reference to line 5C-5C and in FIG. 5C, with the blade 90 having cut through the topping stick 14. A sliced topping 20 is thus cut by the blade 90 from the topping stick 14, and the sliced topping 20 falls downwardly through the elongated opening 100 (FIG. 5C). At the same time, the topping stick 14 falls a short distance so that it rides on the upper surface 94 of the disk 92, and the process of rotating the disk 92 and cutting the topping stick 14 can begin again.

As the sliced topping 20 is cut from the topping stick 14 and falls through the elongated opening 100 in the cutting tool 16, it falls into a chute 114, which is in the shape of a funnel (FIGS. 1-3) having open ends. The chute 114 is positioned below the cutting tool 16 in the preparation chamber 18, and more particularly, below the portion of the elongated opening 100 from which the sliced topping 20 emerges (which is generally below the topping stick 14 that is cut by the cutting tool 16, as shown in FIG. 2). The chute 114 is configured to receive the sliced topping 20 and direct it toward the pizza pie 22. The chute 114 is supported by a chute support 116 that includes brackets 118, 120 mounted to the side walls 54, 56 of the box-like structure 52 connected by arms 122, 124 extending between the brackets 118, 120. A chute plate 126 is positioned on the arms 122, 124 and includes an opening that the chute 114 extends through. When a sliced topping 20 falls through the chute 114, it will land on the pizza pie 22 in a position generally below the bottom of the opening of the chute 114.

Carrier 24 supports the pizza pie 22 and is positioned in the preparation chamber 18. Carrier 24 generally includes a base 128 that is configured for linear movement, or translation, within the chamber 18. To that end, the base 128 is mounted on guide rails 130, 132. Guide rails 130, 132 are suspended above the lower wall 60 of the box-like structure 52 and provide a track along which the base 128 can be linearly translated toward and away from the access door 62. However, it should be noted that the claimed invention should not be limited to linear translation of the carrier 24 toward and away from the access door 62. Rather, the carrier 24 may translate in any direction and need not be limited solely to one direction of linear translation. Thus, the carrier 62 may translate along multiple axes as part of positioning the pizza pie 22 relative to the chute 114.

A turntable 134 is rotatably mounted to the base 128 and includes arms 136 for supporting the pizza pie 22. Particularly, the arms 136 are positioned above the base 128 and advantageously include stepped portions 138, 140, 142 for supporting pizza pies 22 of different sizes.

A carrier drive unit 144 is provided for moving the pizza pie 22 with respect to the chute 114. In particular, the carrier drive unit 144 includes a first motor unit (inside the base 128) to cause the translation movement of the base 128, and a second motor unit (also inside the base 128) to cause the rotational movement of the turntable 134 with respect to the base 128. The motor units for causing translation of the base 128 and rotation of the turntable 134 are advantageously independently controllable. Through the translation of the base 128 and rotation of the turntable 134, every region of the pizza pie 22 can be situated directly beneath the chute 114 in order to receive a sliced topping 20 falling therefrom. Furthermore, the carrier 24 is indexed, such as with an encoder in operative communication with the CPU 86, to track the positions of various components of the carrier to efficiently and accurately place the pizza pie 22 relative to the sliced topping 20 falling from the chute 114.

One or more sensors are operatively connected with the carrier 24, and the access door 62 for determining when a pizza pie 22 is properly positioned within the preparation chamber 18 for positioning the sliced topping 20 onto the pizza pie 22. These sensors include a pizza pie sensor 145, a carrier sensor 146, and a door sensor 147. The sensors 145, 146, 147 and the carrier drive unit 144 are connected with a CPU 148 that controls the drive unit 144. In particular, the CPU 148 directs the drive unit 144 to position the pizza pie 22 in response to the sensors 145, 146, 147 and in response to pre-programmed and predetermined sliced topping patterns. Suitable sliced topping patterns can include any conceivable arrangement of sliced toppings, whether sparingly or liberally applied to the pizza pie 22. As the cutting tool 16 creates sliced toppings 20, the CPU 148 directs the drive unit 144 to translate the base 128 and to rotate the turntable 134 so that the sliced toppings 20 fall onto, or are positioned on, the pizza pie 22 in the desired pattern. The CPU 148 is also connected with user controls 149 accessible at the front panel 36 for selecting or changing the desired pattern. Advantageously, the functions performed by the CPU 86 in conjunction with the topping bin drive unit 76 and the CPU 148 in conjunction with the carrier drive unit 144 could be performed in a single consolidated CPU.

In the exemplary embodiment as best shown in FIGS. 1-3, the pizza pie sensor 145 is mounted to the arms 136 of the turntable 134 and operatively communicates with the CPU 148 for communicating the presence of the pizza pie 22 on the turntable 134. In addition, multiple pizza pie sensors 145 are used to detect the presence and size of the pizza pie 22. Moreover, the carrier sensor 146 is mounted adjacently below the carrier 24, which moves relative to the carrier sensor 146 for sensing the position of the base 128. The carrier sensor 146 operatively communicates to the CPU 148 whether or not the base 128 is properly positioned within the preparation chamber 18 for placing a pizza pie 22 on the carrier 24. This position may be referred to as a home position of the carrier 24. Based on the communication from the one or more pizza pie sensors 145 and the carrier sensor 146, the CPU 148 may initiate properly directing sliced toppings 20 for the properly sized pizza pie 22 at the home position.

Furthermore, the door sensor 147 is mounted to the frame 40 adjacent to the closed access door 62. The door sensor 147 operatively communicates to the CPU 148 whether or not the access door 62 is properly closed in order to prevent operating the pizza pie preparation device 10 while the access door 62 is open. Accordingly, the pizza pie sensor 145, the carrier sensor 146, and the door sensor 147 each communicate with the CPU 148 to affirm that the carrier 24, the access door 62, and pizza pie 22 are all properly positioned for slicing the topping sticks 14 prior to initiating the slicing. As an alternative to the access door 62 and the door sensor 147, a light curtain sensor (not shown), may be mounted adjacent to or within the chamber 18. The light curtain sensor (not shown) may be operatively connected to the CPU 148 and adapted to sense the ingress of a foreign object into the chamber 18 during operation. Should the light curtain sensor (not shown) sense the ingress of the foreign object during the operation of the device 10, the light curtain sensor (not shown) may direct the CPU 148 to cease the operation of the device 10 in order to prevent damage to the device 10 or the foreign object (not shown). In the exemplary embodiment, the pizza pie sensor 145 is a limit switch, the carrier sensor 146 is a proximity sensor, and the door sensor 147 is a proximity sensor. It will be appreciated, however, that various sensors and configurations of sensors may communicate with the CPU 148 for affirming that various features of the pizza pie preparation device 10 are properly positioned for slicing the topping sticks 14 and positioning the pizza pie 22. Thus, the sensors are not intended to be limited to the exemplary embodiment.

The pizza pie preparation device 10 also advantageously includes a refrigeration unit 150 for maintaining the topping sticks 14 within a preset temperature range for producing consistent sliced toppings 20. Generally, consistent sliced toppings 20 slice with sufficient regularity to be properly positioned on the pizza pie 22. Refrigeration unit 150 includes a compressor 152 and cooling tubes 154 for directing a cooling fluid (not shown) therethrough to cool the device 10. Appropriate sealing measures can be included with the protective housing 26 for confining the coolness created by the refrigeration unit 150 within the pizza pie preparation device 10. However, it will be appreciated that any refrigeration unit 150 adapted to sufficiently cool the sliced toppings 20 and the device 10 may be used. For example, as an alternative to the exemplary embodiment of the refrigeration unit 150, the device may include an evaporator (not shown) configured to direct and circulate relatively cold air around the topping bin 64.

In use, the pizza pie preparation device 10 can sequentially place sliced toppings 20 onto a pizza pie 22 in any manner provided for by its structure. Particularly, a pizza pie 22 is placed into the preparation chamber 18 and onto the arms 136 of the turntable 134 on the base 128 of the carrier 24. Positioning of the pizza pie 22 to a predetermined position is accomplished by translating the pizza pie 22 and rotating the pizza pie 22 per the predetermined pattern. Through translation and rotational movement of the pizza pie 22, a predetermined position on the pizza pie 22 is aligned with the chute 114. Advantageously, at the same time the cutting tool 16 is used to slice, or cut, a topping stick 14 to create a sliced topping 20, which is dropped and passes through the elongated opening 100 in the disk 92 of the cutting tool 16 and into the chute 114. The chute 114 guides the sliced topping 20 to the predetermined position on the pizza pie 22. The sequential steps of positioning the pizza pie 22 and cutting the topping stick 14 are repeated until a predetermined pattern of sliced toppings 20 is achieved or completed. Advantageously, a desired topping stick 14 can be selected and the topping bin 64 rotated about its axis of rotation 69 so that the topping chamber 66 containing the desired topping stick 14 is aligned with the apertures 72, 74. Thereby, the topping stick 14 is provided to the cutting tool 16 for creating sliced toppings 20 from the desired topping stick 14. Moreover, the topping stick 14 extends from the selected one of the topping chambers 66 through the apertures 72, 74 in order to position the topping stick 14 adjacent to the cutting tool 16.

By virtue of the foregoing, there is thus provided a pizza pie preparation device 10 for storing topping sticks 14, for cutting the topping sticks 14 into sliced toppings 20, and for positioning the sliced toppings 20 onto the pizza pie 22.

While the present invention has been illustrated by the description of embodiments thereof, and while the embodiments have been described in considerable detail, it is not intended to restrict or in any way limit the scope of the appended claims to such detail. Additional advantages and modifications will readily appear to those skilled in the art. For example, the embodiment of the device 10 described herein cuts from a single topping stick 14; however, such a description is not necessarily limiting. Rather, the invention is intended to broadly include cutting from one or more topping sticks, simultaneously or consecutively, to position sliced toppings in the predetermined pattern on a pizza pie. In that respect, multiple cutting tools 16, blades 90, and/or additional apertures 72, 74 may be used in conjunction with multiple chutes 114, carriers 24, and/or pizza pies 22 to achieve performance benefits readily understood by one skilled in the art. According to the present embodiment, the topping sticks 14 and topping slices 20 are delivered through the topping chamber 66, onto the blade 90, through the chute 114, and onto the pizza pie 22 solely under the influence of gravity. In the alternative, it may be advantageous under certain conditions to apply additional force to the topping sticks 14 and/or the topping slices 20. For instance, springs or additional motors may be used to further urge the topping stick 14 onto the cutting tool 16 to create more efficient or accurate topping slices 20.

Moreover, each CPU 86, 148, sensors 84, 145, 146, 147, and indexed features, such as the cutting tool 16, the topping chambers 66, and the carrier 24, of the claimed invention may be in communication with the user controls 149. The user controls 149, at the user's discretion, functionally operate the device 10 in order to position sliced toppings 20 in accordance with the predetermined pattern onto the pizza pie 22. Such user controls 149 may include, but are not necessarily limited to various sizes of pizza pies 22, speeds, predetermined patterns, or user-defined patterns. The various sizes of pizza pies 22 may include various shapes such as circular, oval, rectangular, and the like. According to the exemplary embodiment, the pizza pie preparation device 10 accommodates pizza pies 22 that are generally round and have a diameter of generally 12 inches and/or generally 15 inches. While the invention described herein may communicate via a CPU 86, 148 to position the sliced topping 20, it should be understood by one skilled in the art that mechanical couplings properly timed could achieve similar benefits.

Furthermore, while the cutting tool 16 described and shown herein may be particularly advantageous to the present embodiment, it is not intended to limit the claimed invention. One skilled in the art will readily recognize that various known cutting tools 16 may prepare sliced toppings 20 in conjunction with the device 10 with appropriate adaptations for the chosen cutting tool. The invention in its broader aspects is, therefore, not limited to the specific detail, representative apparatus and methods and illustrative examples shown and described. Accordingly, departures may be made from such details without departing from the spirit or scope of the general inventive concept.

Having described the invention, what is claimed is:

1. An apparatus for placing a sliced topping from at least one of a plurality of topping sticks onto a pizza pie in a predetermined pattern, comprising:
a storage unit for the plurality of topping sticks;
a cutting tool adjacent to said storage unit configured to slice the at least one of the topping sticks; and
a carrier positioned below said cutting tool, said carrier configured to receive and translate and rotate the pizza pie,
wherein said cutting tool and said carrier are operatively driven to sequentially position the sliced topping from the at least one topping stick onto the pizza pie in the predetermined pattern.

2. The apparatus of claim 1 wherein said cutting tool and said carrier are driven mechanically independently of each other.

3. The apparatus of claim 1 wherein the cutting tool is configured to slice topping from only one topping stick adjacent to said cutting tool.

4. The apparatus of claim 1 including a chute, said chute positioned between said carrier and said cutting tool, wherein said chute is configured to guide sliced topping falling under the influence of gravity toward the pizza pie.

5. The apparatus of claim 4 wherein said chute is a funnel, said funnel sized to accommodate the sliced topping.

6. The apparatus of claim 1 further comprising:
a CPU;
a carrier drive unit, said carrier drive unit operatively connected to said carrier and said CPU;
wherein said CPU directs said carrier drive unit to position said carrier and hence the pizza pie relative to the sliced topping.

7. The apparatus of claim 1 wherein said storage unit further includes:
a storage housing;
a plurality of topping chambers rotatably mounted about a first axis of rotation within said storage housing, each of said topping chambers configured to store one of the topping sticks; and
a storage bottom, said storage bottom including an aperture, wherein said storage housing is configured to align a selected one of said topping chambers with said aperture.

8. The apparatus of claim 7 further comprising:
a topping bin drive unit, said topping bin drive unit operatively connected to said topping chambers to rotate said topping chambers about said first axis of rotation;
a sensor, said sensor configured to sense the topping stick stored by said selected topping chamber aligned with said aperture; and
a CPU, said CPU being operatively connected to said topping bin drive unit and said sensor,
wherein said plurality of topping chambers are indexed such that said CPU directs said topping bin drive unit to rotate said plurality of topping chambers in response to said sensor to maintain a topping stick in said selected chamber aligned with said aperture.

9. The apparatus of claim 1 further comprising a refrigeration unit configured to maintain the plurality of topping sticks within said storage unit within a preset temperature range.

10. The apparatus of claim 1 wherein said cutting tool further includes:
a disk, said disk having a second axis of rotation;
an elongated opening, said elongated opening projecting through said disk and extending about said second axis of rotation;
a blade, said blade connected to said disk and overhanging at least a portion of said elongated opening and having:
a first blade end;
a second blade end; and
said blade having a cutting radius that varies from said first blade end to said second blade end,
wherein said disk is configured to rotate about said second axis of rotation such that one of said first and second blade ends contacts the topping stick and said varying cutting radius of said blade progressively slices the topping stick to form the sliced topping.

11. The apparatus of claim 10 wherein said the cutting radius either increases or decreases from said first blade end to said second blade end such that said first blade end contacts the topping stick and said increasing radius of said blade progressively slices the topping stick to form the sliced topping.

12. The apparatus of claim 10 wherein said elongated opening is curved and said disk further includes an upper disk surface, said blade being connected to said upper disk surface.

13. The apparatus of claim 1 wherein said carrier further includes:
a guide rail;
a base, said base translatably mounted to said guide rail; and
a turntable, said turntable rotatably mounted to said base.

14. The apparatus of claim 13 wherein said base and said turntable are operatively driven by a carrier drive unit to translate and rotate the pizza pie, said carrier drive unit including a pair of independently operable electric motors.

15. The apparatus of claim 1 further comprising:
a protective housing, said protective housing defining a chamber, said carrier and said cutting tool being positioned within said chamber;
an access door, said access door operatively connected to said protective housing to provide access to said chamber; and
a topping cover, said topping cover removably attached to said storage unit to protect the at least one topping stick.

16. An apparatus for placing a sliced topping from at least one of a plurality of topping sticks onto a pizza pie in a predetermined pattern, comprising:
a frame;
a protective housing, said protective housing surrounding at least a portion of said frame and defining a chamber;
a plurality of topping chambers, said plurality of topping chambers rotatably mounted about a first axis of rotation to said frame and extending into said chamber;
a storage bottom, said storage bottom positioned below said plurality of topping chambers and including an aperture, each of said plurality of topping chambers sequentially alignable with said aperture such that a selected one of said plurality of topping chambers is aligned with said aperture;
a disk, said disk rotatably mounted to said frame below said storage bottom and having a second axis of rotation;
a blade, said blade being affixed to said disk;
a guide rail, said guide rail connected to said frame within said chamber and below said disk;
a base, said base translatably mounted to said guide rail; and
a turntable, said turntable rotatably mounted to said base, the pizza pie being received on said turntable,
wherein the at least one topping stick is stored within said selected one of said plurality of chambers and extends through said aperture such that when said disk is rotabably driven, said blade slices the topping,
wherein said base and said turntable are operatively driven such that the pizza pie is linearly translated and rotated to a series of predetermined positions relative to the sliced topping to sequentially deposit the sliced topping on the pizza pie in a predetermined pattern.

17. A cutting tool for slicing a topping for preparation of a pizza pie, comprising:
a disk, said disk having an axis of rotation;
a blade, said blade having:
a first blade end;
a second blade end; and
a cutting radius from said axis of rotation which varies from said first blade end to said second blade end; and
an elongated opening, said elongated opening projecting through said disk and extending about said axis of rotation;
wherein said blade is connected to said disk overhanging at least a portion of the elongated opening.

18. The cutting tool of claim 17 wherein said cutting radius either increases or decreases from said first blade end to said second blade end.

19. The cutting tool of claim 17 wherein said elongated opening is curved and said disk further includes an upper disk surface, said blade being connected to said upper disk surface.

20. A method of placing a topping onto a pizza pie in a predetermined pattern, comprising:
positioning the pizza pie to a predetermined position per the predetermined pattern, including:
translating the pizza pie along a first axis; and
rotating the pizza pie about a second axis;
slicing the topping with a cutting tool;
dropping the sliced topping onto the pizza pie at the predetermined position per the pattern; and
sequentially repeating the positioning, slicing, and dropping steps until the predetermined pattern is complete.

21. The method of claim 20 further including:
selecting one of a plurality of topping chambers which includes the desired topping;
rotating the plurality of topping chambers about a third axis;
locating the selected one of the topping chambers above an aperture;
extending the topping from the selected one of the topping chambers through the aperture; and
positioning the topping adjacent to the cutting tool.

22. The method of claim 20 wherein the cutting tool includes an elongated opening and dropping the sliced topping further includes passing the sliced topping through the elongated opening.

23. The method of claim 20 wherein dropping the sliced topping further includes guiding the sliced topping to the pre-determined position with a chute.
